(19) United States
(12) Patent Application Publication
(10) Pub. No.: US 2026/0234377 A1
(43) Pub. Date: Aug. 13, 2026

(54) POLYMER PROCESSING AIDS BASED ON POLYMERIC PHOSPHITE, POLYDIMETHYLSILOXANE, AND POLYALKYLENE GLYCOL

(71) Applicant: DOW GLOBAL TECHNOLOGIES LLC, Midland, MI (US)

(72) Inventors: Mubashir Qamar Ansari, Midland, MI (US); Amit K. CHAUDHARY, Lake jackson, TX (US); Akanksha GARG, Lake jackson, TX (US); Kurt A. KOPPI, Midland, MI (US); Eric L. MARCHBANKS, Midland, MI (US); Alexander WILLIAMSON, Lake jackson, TX (US)

(73) Assignee: DOW GLOBAL TECHNOLOGIES LLC, Midland, MI (US)

(21) Appl. No.: 19/149,620

(22) PCT Filed: Jan. 24, 2024
(86) PCT No.: PCT/US2024/012727

§ 371 Date: Jul. 21, 2025

Related U.S. Application Data
(60) Provisional application No. 63/481,309, filed on Jan. 24, 2023.

(51) Int. Cl. C08L 23/06; C08J 5/18

(52) U.S. Cl. CPC C08L 23/06; C08J 5/18; C08J 2323/06; C08J 2471/02; C08J 2483/04; C08J 2485/02; C08L 2203/16; C08L 2205/035; C08L 2205/06; C08L 2207/066; C08L 2207/324

(57) ABSTRACT

Embodiments of formulations, for example, polymer processing aid formulations, may include at least at least 95 wt. % of ethylene-based polymer, polymeric phosphite, substituted polydimethylsiloxane (PDMS), and at least 500 ppmw of polyalkylene glycol.

### CROSS REFERENCE TO RELATED APPLICATIONS

This application claims the benefit of and priority to U.S. Application Ser. No. 63/481,309 filed Jan. 24, 2023, the entire contents of which are incorporated by reference in the present disclosure.

### TECHNICAL FIELD

The present disclosure generally relates to formulations comprising ethylene-based polymer, and specifically relates to formulations comprising ethylene-based polymer, and processing aid materials such as polymeric phosphite, substituted polydimethylsiloxane, and polyalkylene glycol.

### BACKGROUND

Plastics are used for a wide range of industrial applications, including packaging, construction, and wire and cable. However, many plastics suffer from melt fracture during extrusion, which is a phenomenon where the surface of the plastic becomes distorted with undulations or irregularities. Some types of melt fracture, such as sharkskin melt fracture, impact the surface of the plastic by causing irregular and sometimes scaly surface texture which may reduce the glossiness of the surface.

Conventional processes for preventing melt fracture in polyethylene include using fluoropolymer-based processing aids. However, concerns that fluorinated chemical compounds may be persistent in the environment have spurred restrictions on these materials, including fluoropolymer-based processing aids. Accordingly, a need exists for improved formulations that may reduce melt fracture, while also alleviating concerns about environmental persistence.

### SUMMARY

Embodiments of the present disclosure address these by the formulations comprising ethylene-based polymer, polymeric phosphite, substituted polydimethylsiloxane, and polyalkylene glycol. The formulations, as described herein, may comprise at least 95 weight percent (wt. %) ethylene-based polymer. The formulation may also comprise at least 500 parts per million by weight (ppmw) polyalkylene glycol. Without being limited by theory, the polymeric phosphite, polydimethylsiloxane, and polyalkylene glycol work in combination as a processing aid to reduce melt fracture.

According to one or more embodiments of the present disclosure, an article may be produced from the above formulations.

Additional features and advantages will be set forth in the detailed description that follows and, in part, will be readily apparent to those skilled in the art from that description or recognized by practicing the embodiments described herein, including the detailed description which follows in addition to the claims.

It is to be understood that both the foregoing general description and the following detailed description describe various embodiments and are intended to provide an overview or framework for understanding the nature and character of the claimed subject matter.

### DETAILED DESCRIPTION

Reference will now be made in detail to embodiments of formulations, e.g., polymer processing aid formulations comprising ethylene-based polymer, polymeric phosphite, substituted polydimethylsiloxane, and polyalkylene glycol. In many embodiments described herein, the polymeric phosphite, substituted polydimethylsiloxane (PDMS), and polyalkylene glycol may be collectively considered to be a processing aid. It is contemplated that additional additives may also be included; however, the formulation is essentially free of fluoropolymer.

Without being bound by theory, the polymeric phosphite, the polyalkylene glycol, and the substituted PDMS may interact with the metal surface of the extruder and with each other such that a lubricating multi-layer is formed between the metal surface and the polyethylene melt, thus reducing melt fracture.

As used in this disclosure, the term “polymer” may refer to a polymeric compound prepared by polymerizing monomers, whether of the same or a different type. The generic term polymer thus embraces the term “homopolymer,” usually employed to refer to polymers prepared from only one type of monomer as well as “copolymer,” which refers to polymers prepared from two or more different monomers. The term “interpolymer,” as used herein, refers to a polymer prepared by the polymerization of at least two different types of monomers. The generic term interpolymer thus includes copolymers, and polymers prepared from more than two different types of monomers, such as terpolymers.

“Blend”, “polymer blend” and like terms mean a composition of two or more polymers. Such a blend may or may not be miscible. Such a blend may or may not be phase separated. Such a blend may or may not contain one or more domain configurations, as determined from transmission electron spectroscopy, light scattering, x-ray scattering, and any other method known in the art. Blends are not laminates, but one or more layers of a laminate may contain a blend. Such blends can be prepared as dry blends, formed in situ (e.g., in a reactor), melt blends, or using other techniques known to those of skill in the art.

As used in this disclosure, the term “polyethylene” or “ethylene-based polymer” may refer to polymers comprising greater than 50% by mole of units which have been derived from ethylene monomer. This includes polyethylene homopolymers or copolymers (meaning units derived from two or more comonomers). Common forms of ethylene-based polymer known in the art include Low Density Polyethylene (LDPE); Linear Low Density Polyethylene (LLDPE); Ultra Low Density Polyethylene (ULDPE); Very Low Density Polyethylene (VLDPE); single-site catalyzed Linear Low Density Polyethylene, including both linear and substantially linear low density resins (m-LLDPE); Medium Density Polyethylene (MDPE); and High Density Polyethylene (HDPE).

The term “LLDPE”, includes both resin made using the traditional Ziegler-Natta catalyst systems and chromium-based catalyst systems as well as single-site catalysts, including, but not limited to, bis-metallocene catalysts (sometimes referred to as “m-LLDPE”), constrained geometry catalysts (CGC), and molecular catalysts. Resins include linear, substantially linear, or heterogeneous polyethylene copolymers or homopolymers. LLDPEs contain less long chain branching than LDPEs and includes the substantially linear ethylene polymers which are further defined in U.S. Pat. Nos. 5,272,236, 5,278,272, 5,582,923 and 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. No. 3,914,342 or U.S. Pat. No. 5,854,045). The LLDPEs can be made via gas-phase, solution-phase or slurry polymerization or any combination thereof, using any type of reactor or reactor configuration known in the art.

As used herein, “polymeric phosphite” refers to polymeric compounds comprising phosphite, and is intended to be interpreted broadly so as to include what might be referred to as oligomeric species. For example, the polymeric phosphite may comprise molecules containing at least three, at least four, at least five, or at least six phosphite-containing units. As another example, the polymeric phosphite may comprise molecules comprising 500 or less, 100 or less, 90 or less, 50 or less, 20 or less, 5 to 500, 5 to 100, 5 to 15, or 3 to 20 phosphite-containing units.

As used herein “fluoropolymer” refers to polymeric compounds comprising fluorine, and is intended to be interpreted broadly so as to include what might be referred to as oligomeric species. For example, the fluoropolymer may comprise molecules containing at least three, at least four, at least five, or at least six fluorine containing units. As another example, the polymeric phosphite may comprise 500 or less, 100 or less, 90 or less, 50 or less, 20 or less, 5 to 500, 5 to 100, 5 to 15, or 3 to 20 fluoride-containing units.

As used herein, “essentially free of” means comprising less than 50 ppmw.

As used herein, “polymer melt” refers to polymers or polymer blends that are at temperatures above their glass transition temperature, i.e. the temperature below which the physical properties of the polymers change to those of a glassy or crystalline state, and usually above their melting temperature. The polymer melts may present as highly viscous liquids, and may possess non-Newtonian or viscoelastic natures.

Various compositions are considered suitable for the ethylene-based polymer. In one or more embodiments, the ethylene-based polymer may comprise linear low density polyethylene (LLDPE). In embodiments, the ethylene-based polymer may comprise a melt index (I₂) of 0.5 g/10 mins as measured according to ASTM D-1238 (190° C./2.16 Kg). In embodiments, the ethylene-based polymer may comprise a melt index of from 0.01 to 2.0 g/10 mins, from 0.2 to 0.8 g/10 mins, from 0.3 to 0.7 g/10 mins, from 0.4 to 0.6 g/10 mins, or from 0.45 to 0.55 g/10 mins. In further embodiments, the ethylene-based polymer may comprise a density from 0.850 to 0.950 g/cc, from 0.875 to 0.925 g/cc, from 0.890 to 0.915 g/cc, or from 0.895 to 0.910 g/cc.

In one or more embodiments, the formulation may comprise at least 95 weight percent (wt. %) of ethylene-based polymer. In embodiments, the formulation may comprise at least 90 wt. %, at least 91 wt. %, at least 92 wt. %, at least 93 wt. %, at least 94 wt. %, at least 95 wt. %, at least 96 wt. %, at least 97 wt. %, at least 98 wt. %, or at least 99 wt. % ethylene-based polymer. In embodiments, the formulation may comprise from 90.0 to 99.9 wt. %, from 91.0 to 99.9 wt. %, from 92.0 to 99.9 wt. %, from 93.0 to 99.9 wt. %, from 94.0 to 99.9% weight, from 95.0 to 99.9% weight, from 95.0 to 99.8 wt. %, from 95.0 to 99.5 wt. %, from 95.0 to 99.3 wt. %, from 95.0 to 99.0 wt. %, from 95.0 to 98.5 wt. %, from 95.0 to 98.0 wt. %, from 95.0 to 97.5 wt. %, from 95.0 to 97.0 wt. %, from 95.0 to 96.5 wt. %, from 95.0 to 96.0 wt. %, or from 95.0 from 95.5 wt. %.

Various compositions are considered suitable for the polyalkylene glycol. For example, the polyalkylene glycol may include polyethylene glycol, polypropylene glycol, polyisopropylene glycol, and combinations thereof. Examples of suitable polyalkylene glycol derivatives include ethers of polyalkylene glycols, mono- and polycarboxylic esters of polyalkylene glycols, and combinations thereof.

In one or more embodiments, the polyalkylene glycol may comprise a polyethylene glycol (PEG) having an average molecular weight (MW) of 1,000 to 40,000 grams per mol (g/mol). In embodiments, the PEG may have an average MW of from 1,000 to 40,000 g/mol, 2,500 to 40,000 g/mol, 5,000 to 40,000 g/mol, 7,500 to 40,000 g/mol, 10,000 to 40,000 g/mol, 20,000 to 40,000 g/mol, 1,000 to 20,000 g/mol, 2,500 to 20,000 g/mol, 5,000 to 20,000 g/mol, 7,500 to 20,000 g/mol, 10,000 to 20,000 g/mol, 1,000 to 10,000 g/mol, 2,500 to 10,000 g/mol, 5,000 to 10,000 g/mol, or 7,500 to 10,000 g/mol.

Moreover, the formulation may comprise at least 500 ppmw of PEG. In embodiments, the formulation may comprise at least 500 ppmw, at least 600 ppmw, at least 700 ppmw, at least 800 ppmw, at least 900 ppmw, or at least 1000 ppmw of PEG. Without being bound by theory, if a minimum amount of 500 ppmw of PEG is not provided in the formulation, it was surprisingly found that the formulation may fail to clear melt fracture, or may fail to clear melt fracture in 120 min or less.

In one or more embodiments, the polymeric phosphite may be a liquid polymeric phosphite. In embodiments, the polymeric phosphite may be a liquid polymeric phosphite having Formula (I), wherein R¹, R², R³ and R⁴ can be the same or different and independently selected from the group consisting of C₁₋₂₀ alkyl, C₂₋₂₂ alkenyl, C₆₋₄₀ cycloalkyl, C₇₋₄₀ cycloalkylene, and Y—OH serving as an end capping moiety for R¹, R², R³ and R⁴; Y is selected from the group consisting of C₂₋₄₀ alkylene, C₂₋₄₀ cycloaliphatic carboxylic esters, and C₃₋₄₀ cycloalkyls; x ranges from 12 to 1,000; wherein R⁷ and R⁹ are independently selected from the group consisting of straight and branched C₁₋₆ alkylene groups, R⁸ is selected from the group consisting of C₅₋₁₀ saturated carbocyclic rings, and a and b are independently selected from the group consisting of 0 and 1. In embodiments, the polymeric phosphite has an average MW of at least 8,000.

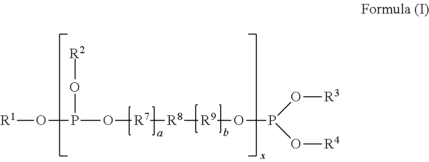

In one or more embodiments, the polymeric phosphite may be a liquid polymeric phosphite having Formula (Ia), wherein wherein R¹, R², R³ and R⁴ can be the same or different and independently selected from the group consisting of C₁₋₂₀ alkyl, C₂₋₂₂ alkenyl, C₆₋₄₀ cycloalkyl, C₇₋₄₀ cycloalkylene, and Y—OH serving as an end capping moiety for R¹, R², R³ and R⁴; Y is selected from the group consisting of C₂₋₄₀ alkylene, C₂₋₄₀ cycloaliphatic carboxylic esters, and C₃₋₄₀ cycloalkyls, and x ranges from 12 to 500. In embodiments, the polymeric phosphite has an average MW of at least 8,000.

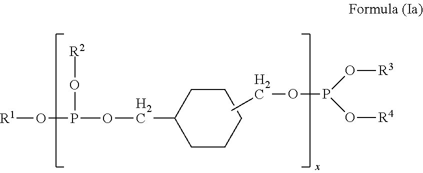

In one or more embodiments, the formulation may include from 1000 ppmw to 2000 ppmw polymeric phosphite. In embodiments, the formulation may include from 500 ppmw to 10000 ppmw, from 550 ppmw to 9500 ppmw, from 600 ppmw to 9000 ppmw, from 650 ppmw to 8500 ppmw, from 700 ppmw to 8000 ppmw, from 750 ppmw to 7500 ppmw, from 800 ppmw to 7000 ppmw, from 900 ppmw to 6500 ppmw, from 950 ppmw to 6000 ppmw, from 1000 ppmw to 5500 ppmw, from 1000 ppmw to 5000 ppmw, from 1000 ppmw to 4500 ppmw, from 1000 to 4000 ppmw, from 1000 ppmw to 3500 ppmw, from 1000 ppmw to 3000 ppmw, from 1000 ppmw to 2500 ppmw, of from 1000 ppmw to 2000 ppmw polymeric phosphite.

“Polydimethylsiloxane” (“PDMS”) is a polymeric organosilicon compound with the following general Formula (II) wherein n is the number of repeating monomer [SiO(CH₃)₂] units and n is greater than or equal to 2, or from 2 to 20,000:

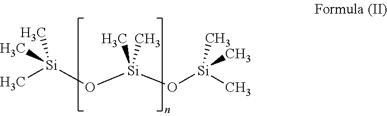

Though the present disclosure is directed toward substituted PDMS, it is contemplated that unsubstituted PDMS may also be used in various formulations. A “substituted PDMS” is a PDMS in which at least one methyl group of Formula (II) is substituted or replaced with a substituent. Non-limiting examples of substituents include halogen atoms (such as chlorine, fluorine, bromine, and iodine); halogen atom-containing groups (such as chloromethyl groups, perfluorobutyl groups, trifluoroethyl groups, and nonafluorohexyl groups); oxygen atom-containing groups (such as hydroxy groups, alkoxy groups (such as methoxy groups and ethoxy groups), (meth)acrylic groups, and carboxyl groups); nitrogen atom-containing groups (such as amino-functional groups, amido-functional groups, and cyano-functional groups); sulphur atom-containing groups (such as mercapto groups); hydrogen; C₂-C₁₀ alkyl groups (such as an ethyl group); C₂-C₁₀ alkynyl groups; alkenyl groups (such as vinyl groups and hexenyl groups); aryl groups (such as phenyl groups and substituted phenyl groups); cycloalkyl groups (such as cyclohexane groups); and combinations thereof. The substituted methyl group may be a terminal methyl group or a non-terminal methyl group. Examples of suitable substituted PDMS include trialkylsilyl terminated PDMS wherein at least one alkyl is a C₂-C₁₀ alkyl; dialkyl hydroxysilyl terminated PDMS; dialkyl hydrogensilyl terminated PDMS; dialkylalkenyl silyl terminated PDMS; and dialkyl vinylsilyl terminated PDMS. In an embodiment, the substituted PDMS is a dimethyl hydroxysilyl terminated PDMS. In another embodiment, the substituted PDMS is a dimethylvinylsilyl terminated PDMS.

In an embodiment, the substituted PDMS excludes nitrogen atom-containing groups. In another embodiment, the substituted PDMS excludes epoxy substituent groups. In an embodiment, the PDMS is unsubstituted. An “unsubstituted PDMS” is the PDMS of Formula (II) wherein no methyl group in Formula (II) is substituted with a substituent. In an embodiment, the unsubstituted PDMS is a trimethylsilyl terminated PDMS.

In another embodiment, the PDMS may comprise silanol terminated PDMS. In one embodiments, the silanol terminated PDMS may have at least one silanol group on at least one end of the polymeric or oligomeric species. In yet another embodiment, the silanol terminated PDMS may have a silanol group on both ends of the polymeric or oligomeric species.

In one or more embodiments, the PDMS may have a kinematic viscosity of at least 1,000 to 100,000 centistokes (cSt). In embodiments, the PDMS may have a kinematic viscosity from 100 to 100,000 cSt, 250 to 100,000 cSt, 500 to 100,000 cSt, 750 to 100,000 cSt, 1,000 to 100,000 cSt, 2,500 to 100,000 cSt, 5,000 to 100,000 cSt, 7,500 to 100,000 cSt, 10,000 to 100,000 cSt, 25,000 to 100,000 cSt, 50,000 to 100,000 cSt, 75,000 to 100,000 cSt, 100,000 to 250,000 cSt, or 100,000 to 500,000 cSt.

In one or more embodiments, the formulation may comprise from 840 ppmw to 1680 ppmw PDMS. In embodiments, the formulation may comprise from 500 ppmw to 10000 ppmw, from 550 ppmw to 9000 ppmw, from 600 ppmw to 8000 ppmw, from 650 ppmw to 7000 ppmw, from 700 ppmw to 6000 ppmw, from 750 ppmw to 5000 ppmw, from 800 ppmw to 4000 ppmw, from 800 ppmw to 3000 ppmw, or from 800 ppmw to 2000 ppmw PDMS.

Moreover, the ratio by weight of the polyalkylene glycol:PDMS:polymeric phosphite may be from 1:1:1 to 1:1:2 to 1:2:2. In embodiments, the ratio by weight of the polyalkylene glycol:PDMS:polymeric phosphite may be from 1:1:1 to 1:1:10, from 1:1:1 to 1:1:5, from 1:1:1 to 1:1:2, from 1:1:1 to 1:10:1, from 1:1:1 to 1:5:1, or from 1:1:1 to 1:2:1.

In one or more embodiments, the formulation may be essentially free of fluoropolymer. In embodiments, the formulation may comprise less than 50 ppmw, less than 40 ppmw, less than 30 ppmw, less than 20 ppmw, less than 10 ppmw, less than 5 ppmw, less than 2 ppmw, or less than 1 ppmw fluoropolymer.

Further optional additives are contemplated for the formulation. In some embodiments, a composition may include one or more other additives. Non limiting examples of suitable other additives include antioxidants, antistatic agents, stabilizing agents, nucleating agents, colorants, pigments, ultra violet (UV) absorbers or stabilizers, slip agents, antiblock agents, flame retardants, compatibilizers, plasticizers, fillers, processing aids, antifog additive, crosslinking agents (e.g., peroxides), and combinations thereof. All individual values and subranges from 0 to 3 wt % are included and disclosed herein; for example, the total amount of additives in the polymer blend can be from a lower limit of 0.5, 1, 1.5, 2, 2.5, 3, 3.5, 4, or 4.5 wt % to an upper limit of 1, 2, 3, 4, or 5 wt %.

Various process procedures are considered suitable for producing the processing aid formulation. For example, it is contemplated to add the processing aid components in various orders. In one or more embodiments, the processing aid may be prepared by first generating a masterbatch of one or more of PDMS, polyalkylene glycol, and polymeric phosphite in a polyethylene resin. In embodiments, generating a masterbatch in a polyethylene resin may comprise compounding a polyethylene resin with one or more of PDMS, polyalkylene glycol, and polymeric phosphite. The masterbatch may be combined with a polymer resin to reduce melt fracture in the base resin in an extruder to fabricate a finished article. The masterbatch may be melt-blended or dry-blended with the base resin before or during extrusion to fabricate an article with reduced melt fracture. The base resin may include ethylene-based polymer, for example, LLDPE.

In one or more embodiments, the formulation may clear melt fracture in less than or equal to 120 minutes (min). In embodiments, the formulation may clear melt fracture in less than 200 min, less than 175 min, less than 150 min, less than 125 min, less than or equal to 120 min, less than or equal to 110 min, less than or equal to 100 min, less than or equal to 90 min, less than or equal to 80 min, less than or equal to 70 min, less than or equal to 60 min, less than or equal to 50 min, or less than or equal to 40 min.

### Articles

In one or more embodiments, an article may be produced from the base resin and the PPA formulations described herein. The articles may include films, for example, monolayer or multilayer films. Articles, which incorporate film, may include non-rigid packages, such as flexible packages, pouches, stand-up pouches, and the like. The articles may also include rigid packages, for example, wires and cable, piping, and the like. Articles may also include tubes or pipes or wires.

### Test Methods

Melt Index (190° C., 2.16 kg, “I₂”) Test Method: ASTM D 1238-13, Standard Test Method for Melt Flow Rates of Thermoplastics by Extrusion Plastometer, using conditions of 190° C./2.16 kilograms (kg). Results were reported in units of grams eluted per 10 minutes (g/10 min.)

Density measurements were performed according to ASTM D4703. Measurements were made, according to ASTM D792, Method B, within one hour of sample pressing.

Average molecular weight (MW) may be determined according to ASTM D4274, the entire protocol of which is hereby incorporated by reference.

Kinematic viscosity was measured for the PDMS using an MCR 301 rheometer commercially available from Anton-Paar. The rheometer was fitted with a 25 millimeter (mm) stainless steel cone-in-plate fixture at an operative temperature of 25° C. Steady shear measurements at shear rates ranging from 0.1 to 500 s−1 were performed. Prior to each measurement, the material was allowed to equilibrate for at least 5 min. The kinematic viscosity is the average viscosity over the shear rate from 0.1-10 s⁻¹.

### EXAMPLES

The following Examples are offered by way of illustration and are presented in a manner such that one skilled in the art should recognize are not meant to be limiting to the present disclosure as a whole or to the appended claims.

The following commercial compositions were used in the Examples below.

DOWLEX™ 2047G, which is a commercial LLDPE resin available from Dow Inc, Midland, MI, has a density of from 0.915 g/cc to 0.919 g/cc and a melt index (I₂) of from 2.0 g/10 mins to 2.6 g/10 mins.

PDMS-1, which is a commercial polydimethylsiloxane silanol functional polymer also available from Dow Inc., has a kinematic viscosity of 50,000 cSt.

PDMS-2, which is a commercial polydimethylsiloxane silicone fluid available from Dow Inc, has a kinematic viscosity of 60,000 cSt.

Comparative Masterbatch comprises 8 wt. % Dynamar™ 5920 fluoropolymer commercially available from 3M, and a Ziegler-Natta catalyzed LLDPE having a density of 0.917 g/cc and a melt index (I2) of 2.3 g/10 mins.

DOVERPHOS© LGP-12 polymeric phosphite, commercially available from Dover Chemical.

CARBOWAX™ 8000 PEG, which is commercially available from Dow Inc, has a molecular weight of from 7000 to 9000 g/mol.

CARBOWAX™ 3350 PEG, which is commercially available from Dow Inc, has a molecular weight of from 3015 to 3685 g/mol.

### Example 1

Experimental LLDPE resin 1, which had a melt index of 0.5 g/10 mins and a density of 0.905 grams per milliliter (g/mL) was produced.

Raw materials and Isopar™ E, a narrow boiling range high-purity isoparaffinic solvent, commercially available from ExxonMobil were purified with molecular sieves. Hydrogen was supplied as a high purity grade and was not further purified.

A two reactor system was used in a series configuration. Each continuous solution polymerization reactor comprised a liquid full, non-adiabatic, isothermal, circulating, loop reactor which mimicked a continuously stirred tank reactor (CSTR) with heat removal. Independent control of all feeds was possible.

Three feed streams: a solvent/ethylene feed stream, a comonomer/ethylene feed stream, and a hydrogen/ethylene feed stream were fed into a first reactor and a second reactor. The feed stream conditions and compositions are shown in Table 1. The feed streams were pressurized via a mechanical compressor or pump to above reaction pressure. The individual catalyst components were manually batch diluted with purified solvent and pressured to above reaction pressure. All reaction feed flows were measured with mass flow meters and independently controlled with computer automated valve control systems.

TABLE 1
Reaction Conditions

| Reactor Configuration | Type | Dual Series |
|---|---|---|
| Comonomer type | Type | 1-octene |
| First Reactor Feed Solvent/Ethylene Mass Flow Ratio | g/g | 5.3 |
| First Reactor Feed Comonomer/Ethylene Mass Flow Ratio | g/g | 0.65 |
| First Reactor Feed Hydrogen/Ethylene Mass Flow Ratio | g/g | 2.0E−04 |
| First Reactor Temperature | ° C. | 141 |
| First Reactor Pressure | barg | 50 |
| First Reactor Ethylene Conversion | % | 79.2 |
| First Reactor Catalyst Type | Type | Catalyst |
| | | component 1 |
| First Reactor Co-Catalyst 1 Type | Type | Co-Catalyst 1 |
| First Reactor Co-Catalyst 2 Type | Type | Co-Catalyst 2 |
| First Reactor Co-Catalyst 1 to Catalyst Molar Ratio (B to Zr | Ratio | 2.0 |
| ratio) | | |
| First Reactor Co-Catalyst 2 to Catalyst Molar Ratio (Al to Zr | Ratio | 74.1 |
| ratio) | | |
| First Reactor Residence Time | min | 17.2 |
| Percentage of Ethylene Feed to First Reactor | wt % | 59.2 |
| Second Reactor Feed Solvent/Ethylene Mass Flow Ratio | g/g | 2.5 |
| Second Reactor Feed Comonomer/Ethylene Mass Flow Ratio | g/g | 0.186 |
| Second Reactor Feed Hydrogen/Ethylene Mass Flow Ratio | g/g | 3.0E−04 |
| Second Reactor Temperature | ° C. | 190 |
| Second Reactor Pressure | barg | 50 |
| Second Reactor Ethylene Conversion | % | 85.9 |
| Second Reactor Catalyst Type | Type | Catalyst |
| | | component 1 |
| Second Reactor Co-Catalyst 1 Type | Type | Co-Catalyst 1 |
| Second Reactor Co-Catalyst 2 Type | Type | Co-Catalyst 2 |
| Second Reactor Co-Catalyst 1 to Catalyst Molar Ratio (B to Zr | mol/mol | 1.4 |
| ratio) | | |
| Second Reactor Co-Catalyst 2 to Catalyst Molar Ratio (Al to Zr | mol/mol | 7.0 |
| ratio) | | |
| Second Reactor Residence Time | min | 7.3 |

The total fresh feed stream to each reactor was temperature controlled to maintain a single solution phase by passing the feed streams through a heat exchanger. The feed streams for each reactor were injected into each reactor at two locations with approximately equal reactor volumes between each injection location. The feed streams were controlled with each injector receiving half of the total fresh feed mass flow.

The catalyst components (shown in Table 2) were injected into each polymerization reactor through specially designed injection stingers. The primary catalyst component feed was computer controlled to maintain each reactor monomer conversion at the specified targets. The cocatalyst components were fed based on calculated specified molar ratios to the primary catalyst component.

TABLE 2
Catalyst Components

| | |
|---|---|
| Catalyst component 1 | 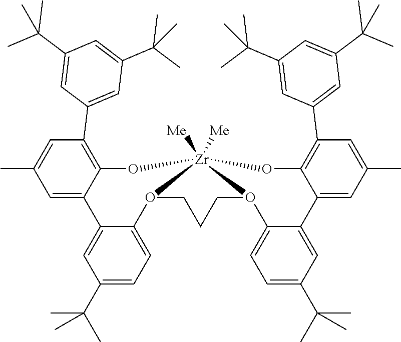 |
| Co-catalyst 1 | Amines, bis(hydrogenated tallow alkyl)methyl, tetrakis(pentafluorophenyl)borate(1-) |
| | R₂MeNH⁺ (R = hydrogenated tallow alkyl) |
| | 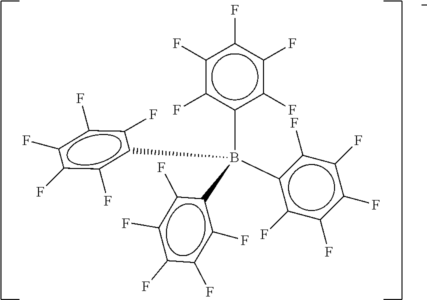 |
| Co-catalyst 2 | Modified Methyl aluminoxane |

Immediately following injection, the feed streams were mixed with the circulating polymerization reactor contents with static mixing elements. The contents of each reactor were continuously circulated through heat exchangers responsible for removing much of the heat of reaction and with the temperature of the coolant side responsible for maintaining an isothermal reaction environment at the specified temperature. Circulation around each reactor loop was provided by a pump.

The effluent from the first polymerization reactor (containing solvent, monomer, comonomer, hydrogen, catalyst components, and polymer) exited the first reactor loop and was added to a second reactor loop.

The final reactor effluent (second reactor effluent for dual series configuration) entered a zone where it was deactivated with the addition of and reaction with a suitable reagent such as water. At this same reactor exit location other additives were added for polymer stabilization (typical antioxidants suitable for stabilization during extrusion and blown film fabrication like octadecyl 3,5-Di-tert-butyl-4-hydroxyhydrocinnamate, tris(2,4-di-tert-butylphenyl)phosphite, and tetrakis(methylene(3,5-di-tert-butyl-4-hydroxyhydrocinnamate))methane).

Following catalyst deactivation and additive addition, the reactor effluent entered a devolatization system where the polymer was removed from the non-polymer stream. The isolated polymer melt was pelletized and collected. The non-polymer stream passed through various pieces of equipment that separated most of the ethylene, which was removed from the system. Most of the solvent and unreacted comonomer were recycled back to the reactor system after passing through a purification system. A small amount of solvent and comonomer was purged from the process.

### Example 2

In the present example, processing aid masterbatches comprising DOWLEX™ 2047G polyethylene resin were generated. In some formulation, the polyethylene resin was compounded with a silicone. In some formulations, the silicone was PDMS-1, or PDMS-2. Additionally, as described above, a Comparative Masterbatch comprising fluoropolymer was also prepared.

Experimental LLDPE resin 1, prepared according to Example 1, was added to a twin screw extruder (TSE) as a base resin, without any processing aid, until the flow was stabilized, which led to melt fracture in the extrudate. The TSE was a ZSK 18 MEGAlab, 18 mm co-rotating TSE, commercially available from Coperion. The TSE had a ratio of the flighted length of the screw to its outside diameter (L/D) of 40, and an outer diameter to inner diameter (Do/Di) ratio of 1.55. The processing conditions used are provided in Table 3. An unplated split body slit die, with dimensions of 10 mm slit width, 10 mm flow length, and 2 mm die gap was used to screen the formulations at an apparent shear rate of 151 s−¹.

TABLE 3
Processing Conditions Used in the TSE

| | |
|---|---|
| Zone 1 temperature (° C.) | 170 |
| Zone 2 temperature (° C.) | 190 |
| Zone 3 temperature (° C.) | 190 |
| Zone 4-7 temperature (° C.) | 190 |
| Screw speed (RPM) | 300 |

Subsequently, the masterbatches and other components were dry blended and fed in the same hopper of the TSE to create polymer processing aid (PPA) formulations as shown in Table 4.

TABLE 4
PPA Formulation by Formulation Number

| | | Comparative | | | PDMS | | | |
|---|---|---|---|---|---|---|---|---|
| | LLDPE | Master | | | Master | | | |
| Formulation | Resin 1 | batch | PDMS | PEG | batch | PDMS | LGP 12 | PEG |
| Number | (wt %) | (wt. %) | (type) | (type) | (wt. %) | (ppmw) | (ppmw) | (ppmw) |
| CE1 | 99 | 1 | | | | | | |
| CE2 | 99.8 | | | | | | 2000 | |
| CE3 | 99.928 | | | Carbowax | | | | 720 |
| | | | | 8000 | | | | |
| CE4 | 97.9 | | PDMS- | | 2.1 | 1680 | | |
| | | | 1 | | | | | |
| CE5 | 99.728 | | | Carbowax | | | 2000 | 720 |
| | | | | 8000 | | | | |
| CE6 | 99.7 | | PDMS- | | 2.1 | 1680 | 2000 | |
| | | | 1 | | | | | |
| CE7 | 97.7 | | PDMS- | | 2.1 | 1050 | 2000 | |
| | | | 2 | | | | | |
| CE8 | 97.828 | | PDMS- | Carbowax | 2.1 | 1680 | | 720 |
| | | | 1 | 8000 | | | | |
| CE9 | 98.814 | | PDMS- | Carbowax | 1.05 | 840 | 1000 | 360 |
| | | | 1 | 8000 | | | | |
| CE10 | 98.15 | | PDMS- | Carbowax | 1.68 | 840 | 1000 | 720 |
| | | | 2 | 8000 | | | | |
| IE1 | 97.628 | | PDMS- | Carbowax | 2.1 | 1680 | 2000 | 720 |
| | | | 1 | 8000 | | | | |
| IE2 | 98.778 | | PDMS- | Carbowax | 1.05 | 840 | 1000 | 720 |
| | | | 1 | 8000 | | | | |
| IE3 | 98.728 | | PDMS- | Carbowax | 1.05 | 840 | 1500 | 720 |
| | | | 1 | 8000 | | | | |
| IE4 | 98.253 | | PDMS- | Carbowax | 1.575 | 1260 | 1000 | 720 |
| | | | 1 | 8000 | | | | |
| IE5 | 99.78 | | PDMS- | Carbowax | 1.05 | 840 | 1000 | 720 |
| | | | 1 | 3350 | | | | |

Following the attainment of melt fracture, the PPA formulations were introduced, and the time required for visual clearance of the melt fracture was recorded, as shown in Table 5. The timer was started when the formulation was introduced in the extruder after the extrusion was stabilized with the base resin. If melt fracture was not cleared after 120 minutes, the timer was stopped.

After every formulation, the extruder was purged with the base resin until the melt fracture was fully re-established, confirmed visually as well by the stabilization of the processing conditions (extruder torque, pressure). The processing data for the PPA formulations are listed in Table 6.

TABLE 5
Time to Clear Melt Fracture by Formulation Number

| Formulation | |
|---|---|
| Number | Time to clear melt fracture (min) |
| CE1 | 100 |
| CE2 | Did not clear at 120 minutes |
| CE3 | Did not clear at 120 minutes |
| CE4 | Did not clear at 120 minutes |
| CE5 | Did not clear at 120 minutes |
| CE6 | Did not clear at 120 minutes |
| CE7 | Did not clear at 120 minutes |
| CE8 | Did not clear at 120 minutes |
| CE9 | Did not clear at 120 minutes |
| CE10 | Did not clear at 120 minutes |
| IE1 | 70 |
| IE2 | 40 |
| IE3 | 110 |
| IE4 | 40 |
| IE5 | 80 |

TABLE 6
Process data for Various Formulations

| | | | Specific | | Extruder |
|---|---|---|---|---|---|
| | Melt | | Mechanical | Die | Outlet |
| Formulation | Temperature | Torque | Energy | Pressure | Pressure |
| Number | (° C.) | (%) | (J/g) | (psi) | (psi) |
| CE1 | 240.9 | 58.5 | 2316.6 | 500-575 | 1550-1650 |
| CE2 | 243.0 | 57.5 | 2277.0 | 620-680 | 1600-1700 |
| CE3 | 240.7 | 63.5 | 2514.6 | 590-750 | 1700-1750 |
| CE4 | 240.5 | 54.0 | 2138.4 | 610-725 | 1700-1715 |
| CE5 | 239.5 | 56.5 | 2237.4 | 525-595 | 1590-1660 |
| CE6 | 241.9 | 56.5 | 2237.4 | 560-660 | 1650-1750 |
| CE7 | 244.3 | 54.5 | 2158.2 | 530-630 | 1580-1650 |
| CE8 | 240.1 | 58.0 | 2296.8 | 590-700 | 1690-1700 |
| CE9 | 243.0 | 55.0 | 2178.0 | 485-570 | 1540-1625 |
| CE10 | 246.6 | 58.0 | 2296.8 | NA | 1650-1750 |
| IE1 | 241.1 | 54.5 | 2158.2 | 460-540 | 1440-1520 |
| IE2 | 241.8 | 53.5 | 2118.6 | 475-550 | 1480-1500 |
| IE3 | 243.6 | 55.5 | 2197.8 | 480-555 | 1450-1525 |
| IE4 | 241.6 | 54.5 | 2158.2 | 510-585 | 1500-1560 |
| IE5 | 246.7 | 58.0 | 2296.8 | NA | 1600-1700 |

As shown in Tables 4 and 5, CE2, which had only polymeric phosphite as a processing aid, CE3, which had only PEG as a processing aid, and CE4, which had only PDMS as a processing aid all failed to clear melt fracture within 120 minutes.

Furthermore, as shown by CE4-CE8, formulations that only comprised two processing aid components selected from the list consisting of PEG, polymeric phosphite, and PDMS also did not clear the melt fracture within 120 minutes.

Additionally, formulations that comprise polyalkylene glycol, polymeric phosphite, and PDMS may not be as effective when less than 500 ppmw of PEG is used, as is shown by CE9, which only used 360 ppmw of PEG and only partially cleared the melt fracture after 120 min.

Furthermore, formulation CE10, which utilized an unsubstituted PDMS failed to clear melt fracture within 120 minutes.

IE1-IE5, which comprised PEG, polymeric phosphite, and substituted PDMS as a processing aid, cleared melt fracture in less than 120 minutes. Moreover, they cleared melt fracture even faster than CE1, which was a formulation comprising fluoropolymer. This is even more significant when considering that that the inventive formulations do not include the same environmental persistence concerns as fluoropolymer processing aids.

The subject matter of the present disclosure has been described in detail and by reference to specific embodiments. It should be understood that any detailed description of a component or feature of an embodiment does not necessarily imply that the component or feature is essential to the particular embodiment or to any other embodiment. Further, it should be apparent to those skilled in the art that various modifications and variations can be made to the described embodiments without departing from the spirit and scope of the claimed subject matter.

It is noted that one or more of the following claims utilize the term “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

It should be understood that where a first component is described as “comprising” a second component, it is contemplated that, in embodiments, the first component “consists” or “consists essentially of” that second component. It should further be understood that where a first component is described as “comprising” a second component, it is contemplated that, in embodiments, the first component comprises at least 10%, at least 20%, at least 30%, at least 40%, at least 50%, at least 60%, at least 70%, at least 80%, at least 90%, at least 95%, or even at least 99% that second component (where % can be weight % or molar %).

It is also noted that recitations herein of “at least one” component, element, etc., should not be used to create an inference that the alternative use of the articles “a” or “an” should be limited to a single component, element, etc.

1. A formulation comprising:
at least 95 wt. % of ethylene-based polymer;
polymeric phosphite;
substituted polydimethylsiloxane (PDMS); and
at least 500 ppmw of polyalkylene glycol.

2. The formulation of claim 1, wherein the polyalkylene glycol is a polyethylene glycol (PEG) having an average molecular weight (MW) of 1,000 g/mol to 40,000 g/mol.

3. The formulation of claim 1, wherein the formulation is essentially free of fluoropolymer.

4. The formulation of claim 1, wherein the polymeric phosphite is liquid polymeric phosphite.

5. The formulation of claim 1, wherein the substituted PDMS comprises hydroxy groups, carboxyl groups, amino-functional groups, or combinations thereof.

6. The formulation of claim 1, wherein the substituted PDMS comprises silanol terminated PDMS.

7. The formulation of claim 1, wherein the substituted PDMS has a kinematic viscosity of at least 1,000 centistokes (cSt) to 100,000 cSt.

8. The formulation of claim 1, wherein the ethylene-based polymer comprises linear low density polyethylene (LLDPE).

9. An article produced from the formulation of claim 1.

10. A method of making an article comprising: extruding a polymer melt comprising the formulation of claim 1 to produce the article.

11. The method of claim 10, wherein the article comprises rigid articles and films.
